(19) United States
(12) Patent Application Publication
(10) Pub. No.: US 2022/0401282 A1
(43) Pub. Date: Dec. 22, 2022

(54) INTEGRATED DENTAL CARE SYSTEM

(71) Applicant: Madappa Belliappa Puttichanda, Bangalore (IN)

(72) Inventor: Madappa Belliappa Puttichanda, Bangalore (IN)

(21) Appl. No.: 17/822,459

(22) Filed: Aug. 26, 2022

Related U.S. Application Data
(63) Continuation of application No. 16/444,337, filed on Jun. 18, 2019.

(51) Int. Cl. A61G 15/00; A61C 17/022; A61G 15/16; A61C 17/14; A61C 17/06; A61G 15/02; A61G 15/10

(52) U.S. Cl. CPC A61G 15/002; A61C 17/022; A61G 15/16; A61C 17/14; A61C 17/06; A61G 15/02; A61G 15/00; A61G 15/10; A61C 1/0053

(57) ABSTRACT

An integrated dental care system is disclosed. The integrated dental care system includes a dental recliner chair and a dental treatment unit. The dental recliner chair includes a foldable chair frame which folds at coupling point(s), a foldable chair supporting frame which enables folding and unfolding of the foldable chair frame, a pair of side chair arms including multiple serrated edges for locking a reclination of a back supporting frame at a first reclination angle and vary the reclination to second reclination angle(s), when a second end of the pair of the side chair arms is lifted and locked at second serrated edge(s) of the multiple serrated edges. The dental treatment unit includes a housing including a compressor unit generating compressed air, a pressure controlling unit stepping down the first predefined pressure, and multiple ventilation opening(s) for ventilation. The dental treatment unit includes a toolbox holding instruments for dental treatment.

### CROSS REFERENCE TO RELATED APPLICATIONS

This application is a continuation-in-part of U.S. patent application and claims priority benefit of, pending United States Non Provisional Specification bearing application Ser. No. 16/444,337 filed on Jun. 18, 2019 entitled “INTEGRATED DENTAL CARE SYSTEM” which is hereby incorporated by reference in its entirety.

### FIELD OF INVENTION

Embodiments of the present disclosure relate to mobile dental clinics, and more particularly, to an integrated dental care system having a portable chair and a portable dental treatment kit.

### BACKGROUND

The primary use of dental clinics is to prevent complications such as tooth decay (cavities) and gum disease and to maintain the overall health of the mouth. Regular dental chairs and dental tools are not mobile. Usually, the dental chair and compressor, and suction unit are placed at a particular place in a dental clinic. So, the patient has to visit the dental clinic for dental service. According to World Health Organization (WHO), a child must visit a dentist once in 6 months and an adult once a year.

In a conventional approach, a person has to visit a dental clinic at regular times. The clinic facilities are permanently fixed in a particular place. A more effective service would be to provide a mobile dental clinic. Here, the dental tools and the dental chair should be accessible to all kinds of people. Moreover, the permanently fixed and bulky arrangement of dental instruments surely makes the installation cost very high. So, low-cost, dependable, and easy-to-move dental instruments would surely enable the dentist in providing service.

Hence, there is a need for an improved integrated dental care system to address the aforementioned issue(s).

### BRIEF DESCRIPTION

In accordance with an embodiment of the present disclosure, an integrated dental care system is provided. The integrated dental care system includes a dental recliner chair. The integrated dental care system also includes a dental treatment unit operatively coupled with the dental recliner chair. The dental recliner chair includes a foldable chair frame. The foldable chair frame includes one or more frame components. The one or more frame components include a contoured headrest element, a back supporting frame, a seat supporting frame, and a calf supporting frame mechanically coupled with each other at one or more coupling points. The foldable chair frame is adapted to fold at the corresponding one or more coupling points when operated by a user. The dental recliner chair also includes a foldable chair supporting frame mechanically coupled to the foldable chair frame. The foldable chair supporting frame includes a U-shaped rear leg frame and a U-shaped front leg frame pivotally coupled with each other at a pair of pivot points. The foldable chair supporting frame is adapted to enable folding and unfolding of the foldable chair frame when operated by the user. The dental recliner chair further includes a pair of side chair arms. Each of the pair of side chair arms is pivotally coupled to the back supporting frame at a first end of the pair of side chair arms. Each of the pair of side chair arms includes a plurality of serrated edges on a first surface of the corresponding pair of side chair arms. The plurality of serrated edges is adapted to receive the pair of pivot points at a first serrated edge of the plurality of serrated edges for locking a reclination of the back supporting frame at a first reclination angle. The plurality of serrated edges is also adapted to vary the reclination of the back supporting frame from the first reclination angle to one or more second reclination angles, when a second end of the pair of the side chair arms is lifted and locked at one or more second serrated edges of the plurality of serrated edges by the user. The dental treatment unit includes a housing. The housing includes a compressor unit. The compressor unit is adapted to generate compressed air by compressing air to a first predefined pressure using a motor of a predetermined horsepower. The housing also includes a pressure controlling unit operatively coupled to the compressor unit. The pressure controlling unit is adapted to step down the first predefined pressure to one or more second predefined pressures for operating a plurality of handpieces. The housing further includes a plurality of ventilation openings to provide ventilation for preventing over-heating of the compressor unit. The dental treatment unit also includes a toolbox detachably coupled to the housing. The toolbox is adapted to hold a plurality of instruments essential to be used by a dentist for dental treatment.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of an isometric view of an integrated dental care system in accordance with an embodiment of the present disclosure;

FIG. 2 is a schematic representation of an embodiment of an isometric view of a dental recliner chair of the integrated dental care system of FIG. 1 in accordance with an embodiment of the present disclosure;

FIG. 3 is a schematic representation of an embodiment of a side view of a dental recliner chair of the integrated dental care system of FIG. 1 in accordance with an embodiment of the present disclosure;

FIG. 4 is a schematic representation of an embodiment of a bottom view of one of a pair of side chair arms of the dental recliner chair of FIG. 2 illustrating a plurality of serrated edges in accordance with an embodiment of the present disclosure;

FIG. 5 is a different angular representation of an embodiment of a reclination of a dental recliner chair of the integrated dental care system of FIG. 1 in accordance with an embodiment of the present disclosure:

FIG. 6 is a schematic representation of an embodiment of an isometric view of a dental treatment unit of the integrated dental care system of FIG. 1 in accordance with an embodiment of the present disclosure;

FIG. 7 is a schematic representation of an embodiment of an isometric view of a toolbox of the dental treatment unit of FIG. 6 in accordance with an embodiment of the present disclosure;

FIG. 8 is a detailed-view representation of an embodiment of an isometric view of the dental treatment unit of FIG. 6 in accordance with an embodiment of the present disclosure; and

FIG. 9 is a schematic representation of an embodiment of an isometric view of a spittoon unit of the integrated dental care system of FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

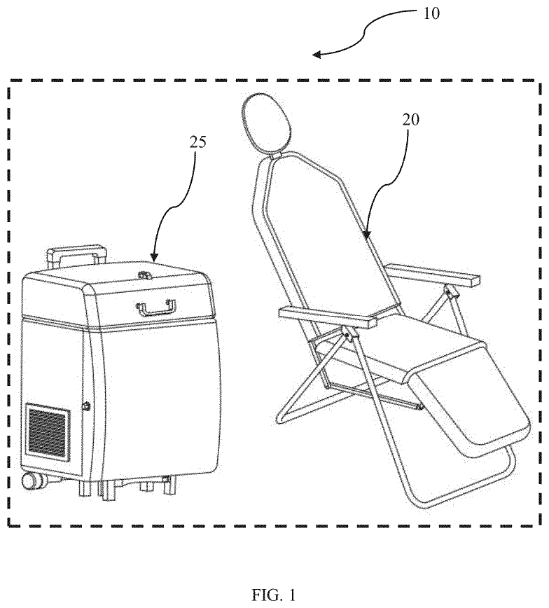

Embodiments of the present disclosure relate to an integrated dental care system. As used herein, the term “dental care system” refers to a system used for total oral healthcare. Further, as used herein, the term “integrate” refers to linking or coordinating various parts or aspects functioning together as a whole. Therefore, as used herein, the term “integrated dental care system” is defined as a dental care system in which a dental chair and a dental treatment kit are integrated with each other for functioning as a single unit. Thus, the integrated dental care system described hereafter in FIG. 1 is the integrated dental care system including a dental recliner chair and a dental treatment unit operatively coupled to the dental recliner chair.

FIG. 1 is a schematic representation of an isometric view of an integrated dental care system 10 in accordance with an embodiment of the present disclosure. The integrated dental care system 10 includes a dental recliner chair 20. The integrated dental care system 10 also includes a dental treatment unit 25 operatively coupled with the dental recliner chair 20. As used herein, the term, “dental recliner chair” is referred to a chair on which a user sits comfortably during check-ups or operations corresponding to a dental treatment carried out by a dentist. In one embodiment, the user may be a patient suffering from a dental problem.

Further, in one embodiment, the dental recliner chair 20 may be a portable dental recliner chair. As used herein, the term “portable” means to be easily carried or moved, especially because being of a lighter and smaller version than usual. Therefore, in an embodiment, the dental recliner chair 20 may be adapted to be folded and packed in a backpack with shoulder pads. Moreover, in an embodiment, the dental recliner chair 20 may be folded and packed or unfolded and unpacked within about 30 seconds each.

In one exemplary embodiment, the dental recliner chair 20 may have a load-bearing capacity of about 120 kilograms (kgs). Also, in an embodiment, the dental recliner chair 20 may weigh about 9 kgs to about 12 kgs. Further, in an embodiment, the dental recliner chair 20 may be provided with a polyurethane foam cover for ease of serviceability and maintenance. Furthermore, in an embodiment, the dental recliner chair 20 may be covered with a soft fabric nylon cloth contoured for reverse pressure.

In addition, as used herein, the term “dental treatment unit” refers to a compact unit or compact equipment enclosing a plurality of elements needed for a dental treatment of a patient with a dental problem. In one embodiment, the dental treatment unit 25 may also be portable. In one exemplary embodiment, the dental treatment unit 25 may weigh about 16 kgs to about 25 kgs. Further, in an embodiment, the dental treatment unit 25 may have a height of about 2.5 feet, a weight of about 1.5 feet, and a depth of about 1.25 feet.

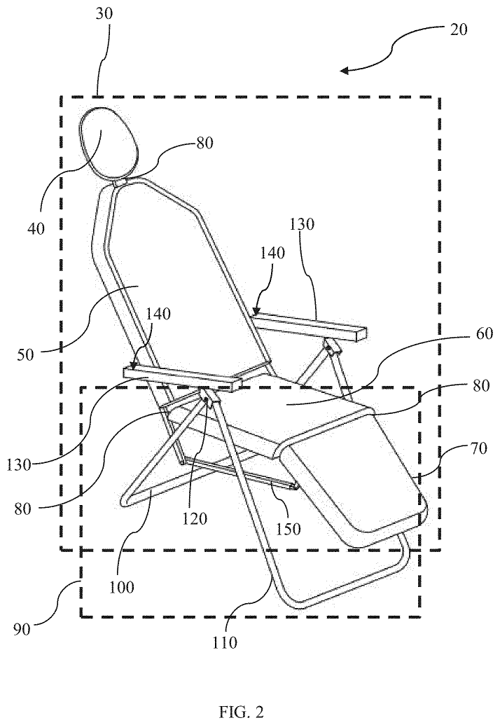

FIG. 2 is a schematic representation of an embodiment of an isometric view of the dental recliner chair 20 of the integrated dental care system 10 of FIG. 1 in accordance with an embodiment of the present disclosure. As used herein, the term “recliner” refers to a chair with a reclining back, especially one with an integral footrest. Thus, in an embodiment, the dental recliner chair 20 may be a dental chair with a reclining capability.

The dental recliner chair 20 includes a foldable chair frame 30. As used herein, the term “frame” refers to a rigid structure that surrounds a whole structure of a chair. The foldable chair frame 30 includes one or more frame components. As used herein, the term “chair frame” refers to a frame supporting the dental recliner chair on which the patient rests. The one or more frame components include a contoured headrest element 40, a back supporting frame 50, a seat supporting frame 60, and a calf supporting frame 70 mechanically coupled with each other at one or more coupling points 80.

In one embodiment, the contoured headrest element 40 may be adapted to provide support to a head of the user resting on the dental recliner chair 20. In another embodiment, the back supporting frame 50 may be adapted to provide a support to a back of the user resting on the dental recliner chair 20. Similarly, in yet another embodiment, the seat supporting frame 60 may be adapted to enable the user to sit on the dental recliner chair 20. Further, in yet another embodiment, the calf supporting frame 70 may be adapted to provide a support to a calf portion of legs of the user resting on the dental recliner chair 20.

Subsequently, the dental recliner chair 20 also includes a foldable chair supporting frame 90 mechanically coupled to the foldable chair frame 30. The foldable chair supporting frame 90 includes a U-shaped rear leg frame 100 and a U-shaped front leg frame 110 pivotally coupled with each other at a pair of pivot points 120.

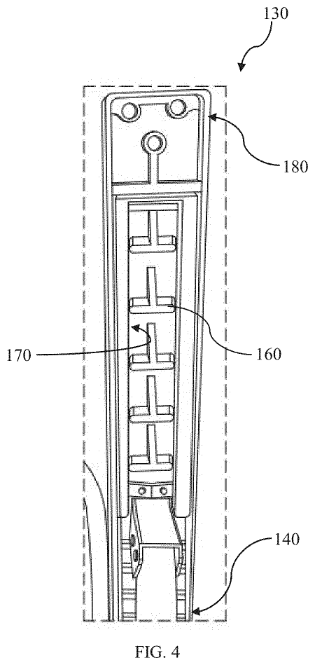

The dental recliner chair 20 further includes a pair of side chair arms 130. As used herein, the term “side chair arms” refers to a portion of the dental recliner chair 20 that enables resting of arms of the user resting on the corresponding dental recliner chair 20. Each of the pair of side chair arms 130 is pivotally coupled to the back supporting frame 50 at a first end 140 of the pair of side chair arms 130. Each of the pair of side chair arms 130 includes a plurality of serrated edges as shown in FIG. 4 on a first surface of the corresponding pair of side chair arms 130.

The plurality of serrated edges is adapted to receive the pair of pivot points 120 at a first serrated edge of the plurality of serrated edges for locking a reclination of the back supporting frame 50 at a first reclination angle. In an embodiment, the first reclination angle may be about 30 degrees.

In addition, in an embodiment, the reclination of the back supporting frame 50 may be adapted to control a reclination of the calf supporting frame 70 via a connecting shaft 150. The connecting shaft 150 may be pivotally coupled between the back supporting frame 50 and the calf supporting frame 70.

Also, in an embodiment, the foldable chair frame 30, and a frame of the pair of side chair arms 130 may be fabricated using Mild steel (MS). Further, in an embodiment, a top surface of the pair of side chair arms 130 may be fabricated using Acrylonitrile butadiene styrene (ABS) plastic.

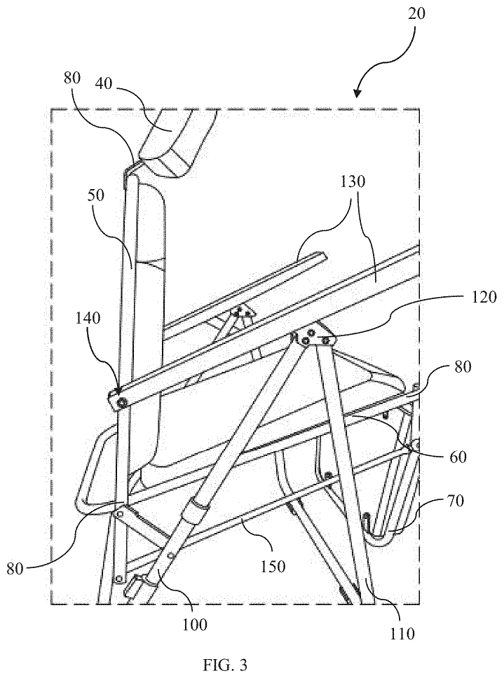

FIG. 3 is a schematic representation of an embodiment of a side view of the dental recliner chair 20 of the integrated dental care system 10 of FIG. 1 in accordance with an embodiment of the present disclosure. The foldable chair frame 30 is adapted to fold at the corresponding one or more coupling points 80 when operated by the user. In such an embodiment, the user may be a patient or a dentist. In one exemplary embodiment, the one or more coupling points 80 may be one or more pivot points. The foldable chair supporting frame 90 is adapted to enable folding and unfolding of the foldable chair frame 30 when operated by the user.

FIG. 4 is a schematic representation of an embodiment of a bottom view of one of the pair of side chair arms 130 of the dental recliner chair 20 of FIG. 2 illustrating the plurality of serrated edges 160 in accordance with an embodiment of the present disclosure. Basically, each of the pair of side chair arms 130 includes the plurality of serrated edges 160 on the first surface 170 of the corresponding pair of side chair arms 130. In one embodiment, the first surface 170 of the pair of side chair arms 130 may correspond to a bottom portion of the corresponding pair of side chair arms 130. As used herein, the term “serrated edges” refers to edges that have been lined with small teeth, similar to a saw's. In such embodiment, the presence of the plurality of serrated edges 160 gives extra protection, as the dental recliner chair 20 is dislocated while in use.

In one exemplary embodiment, the plurality of serrated edges 160 may be inclined at a predefined angle, wherein the predefined angle may include about 45 degrees. Further, in an embodiment, the plurality of serrated edges 160 may have a predefined spacing between the corresponding plurality of serrated edges 160. The predefined spacing may include about two inches.

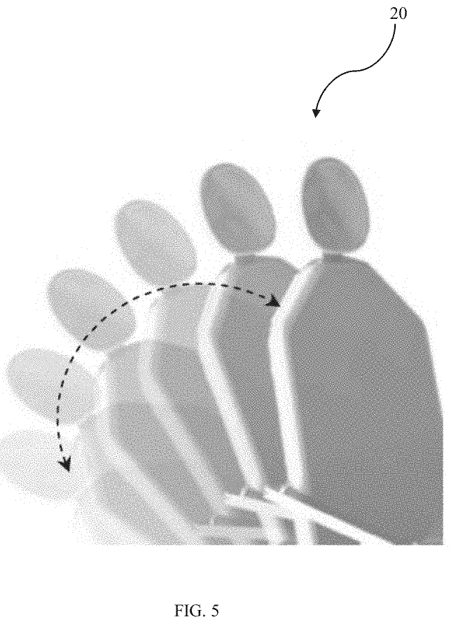

The plurality of serrated edges 160 is also adapted to vary the reclination of the back supporting frame 50 from the first reclination angle to one or more second reclination angles as shown in FIG. 5, when a second end 180 of the pair of side chair arms 130 is lifted and locked at one or more second serrated edges of the plurality of serrated edges 160 by the user.

In one exemplary embodiment, the one or more second reclination angles may include about 60 degrees, 90 degrees, 120 degrees, 160 degrees, and the like. In such embodiment, the one or more second serrated edges may include a second serrated edge to achieve the reclination of the back supporting frame 50 to be about 60 degrees. In such another embodiment, the one or more second serrated edges may include a third serrated edge to achieve the reclination of the back supporting frame 50 to be about 90 degrees. Further, in such another embodiment, the one or more second serrated edges may include a fourth serrated edge to achieve the reclination of the back supporting frame 50 to be about 120 degrees. Furthermore, in such another embodiment, the one or more second serrated edges may include a fifth serrated edge to achieve the reclination of the back supporting frame 50 to be about 160 degrees.

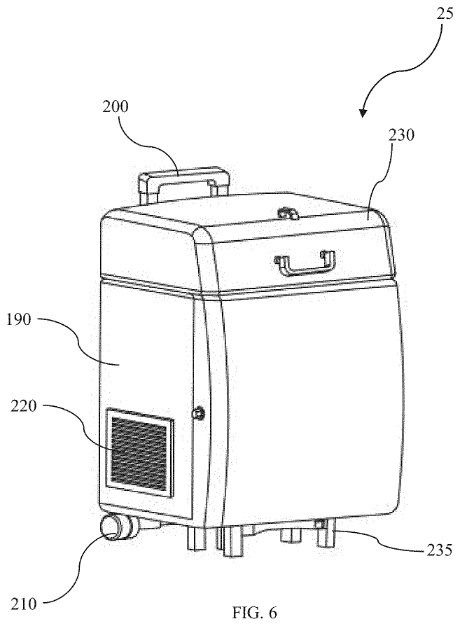

FIG. 6 is a schematic representation of an embodiment of an isometric view of the dental treatment unit 25 of the integrated dental care system 10 of FIG. 1 in accordance with an embodiment of the present disclosure. As used herein, “dental treatment” refers to medical care given to a patient for an illness or injury related to teeth. The dental treatment unit 25 includes a housing 190. As used herein, the term “housing” refers to a rigid casing that encloses and protects a piece of equipment. In one exemplary embodiment, the housing 190 may be fabricated using Fiberglass Reinforced Plastics (FRP) material. Such fabrication enables long life and less maintenance.

In one embodiment, the housing 190 may be mounted on a trolley system for providing mobility to the dental treatment unit 25. The trolley system may include an adjustable handle 200 and a plurality of wheels 210. Further, in an embodiment, a time taken for mounting the housing 190 onto the trolley system may be about 30 seconds.

The housing 190 includes a compressor unit (not shown in FIG. 6). The compressor unit is adapted to generate compressed air by compressing air to a first predefined pressure using a motor of a predetermined horsepower. In one embodiment, the first predefined pressure may include about 8 bar pressure. Further, in an embodiment, the predetermined horsepower of the motor may include about 1 horsepower. In one exemplary embodiment, the motor may include an air motor, a micromotor, or the like.

The housing 190 also includes a pressure controlling unit (not shown in FIG. 6) operatively coupled to the compressor unit. The pressure controlling unit is adapted to step down the first predefined pressure to one or more second predefined pressures for operating a plurality of handpieces. In one embodiment, the one or more second predefined pressures may include about 2 bar pressure to about 5 bar pressure.

In one embodiment, the compressor unit may be adapted to store the compressed air in an aluminum tank. In one exemplary embodiment, the aluminum tank may have a capacity of about 7 liters. In a specific embodiment, the aluminum tank may include a plurality of outlets connected to a plurality of first tubes. The plurality of first tubes may be adapted to connect to one or more inlet valves of the pressure controlling unit for enabling the pressure controlling unit to receive the compressed air with the first predefined pressure.

Basically, in an embodiment, the pressure controlling unit may include at least one of the one or more inlet valves, one or more outlet valves, one or more connectors, one or more actuators, one or more regulators, and one or more controllers operatively coupled with each other for enabling the stepping down of the first predefined pressure of the compressed air to the one or more second predefined pressures. Further, in a specific embodiment, the one or more inlet valves and the one or more outlet valves may be specially designed for maintaining a constant flow rate. Further, in an embodiment, the pressure controlling unit may use pneumatic bush fittings.

The housing 190 further includes a plurality of ventilation openings 220 to provide ventilation for preventing over-heating of the compressor unit. In one embodiment, the housing 190 may also include an air filtration unit (not shown in FIG. 6) operatively coupled to the compressor unit. The air filtration unit may be adapted to filter the compressed air using a predefined filtration mechanism. The dental treatment unit 25 also includes a toolbox 230, detachably coupled to the housing 190. In one embodiment, the predefined filtration mechanism may provide high-quality pure air upon filtration at 5-micron filtration.

In an exemplary embodiment, the dentist specifically needs the compressed air, vacuum, and water at the dental recliner chair 20 when performing at least one of one or more dental treatment operations and suctioning out waste fluids. The housing 190 enclosing the compressor unit and the pressure controlling unit is specifically designed to make such instruments available to the dentist. In one embodiment, the housing 190 may be small enough to be fitted in a portable unit. Moreover, the compressor unit may be mounted on a frame 235 to prevent noise and vibration.

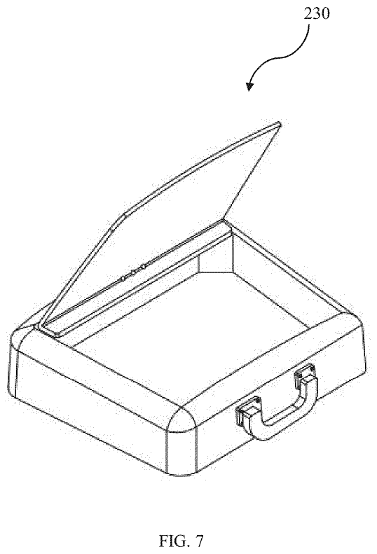

FIG. 7 is a schematic representation of an embodiment of an isometric view of the toolbox 230 of the dental treatment unit 25 of FIG. 6 in accordance with an embodiment of the present disclosure. In one embodiment, the toolbox 230 may be positioned on top of the housing 190. The toolbox 230 is adapted to hold a plurality of instruments essential to be used by the dentist for the dental treatment. In one exemplary embodiment, the plurality of instruments may include a mouth mirror, a dental probe, an anesthetic, a spoon excavator, and the like.

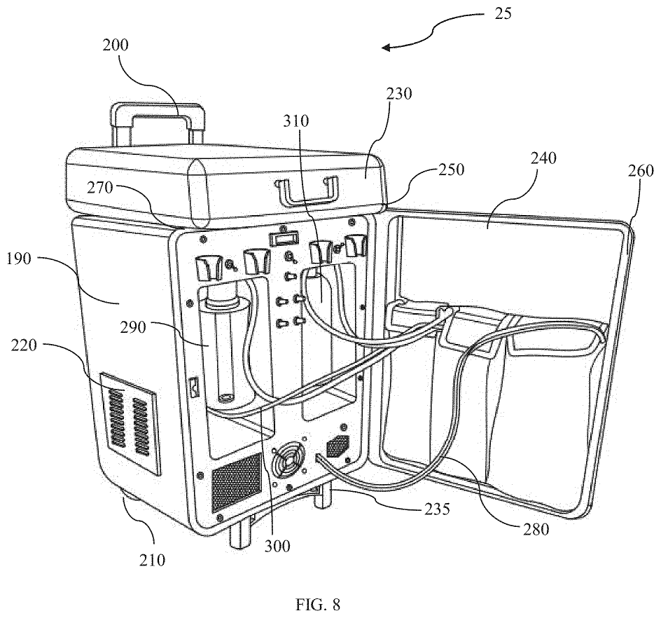

FIG. 8 is a detailed-view representation of an embodiment of an isometric view of the dental treatment unit 25 of FIG. 6 in accordance with an embodiment of the present disclosure. In one exemplary embodiment, the housing 190 of the dental treatment unit 25 may have a door-like structure 240 hinged at a first edge 250 of the housing 190. The door-like structure 240 may be adapted to provide protection to a cavity carrying a plurality of elements needed for the dental treatment of the patient with the dental problem, by locking a distal end 260 of the door-like structure 240 to a second edge 270 of the housing 190 using a door locking mechanism. Basically, in an embodiment, the pressure controlling unit may be adapted to step down the first predefined pressure for operating the plurality of handpieces. In one exemplary embodiment, the plurality of handpieces may include at least one of a high-speed handpiece, a low-speed high-torque handpiece, a 3-way syringe, a suction-based saliva ejector, a water spray, an air rotor, and the like.

As used herein, the term “high-speed handpiece” refers to a handheld dental scaling and cutting instrument that rotates at up to about 450,000 Revolutions per minute (RPM), powered by miniature turbines and driven by compressed air or an electric motor. As used herein, the term “low-speed high-torque handpiece” refers to an electric or air-powered handpiece that typically operates at about 60,000 Revolutions per minute (RPM) or lower, used for general cutting, grinding, and polishing.

As used herein, the term “3-way syringe” refers to a syringe having separate internal channels supplying air, water or a mist created by combining the pressurized air with the water flow. Here, a syringe tip can be separated from the main body and replaced when necessary. As used herein, the term “suction-based saliva ejectors” refers to vacuum cleaners for a mouth, whereby narrow tubes that dentists and other oral health care professionals use for suction of saliva, blood, and debris from the mouth.

As used herein, the term “water spray” refers to a water spraying unit used for spraying water inside the mouth of a patient for cooling, flushing, and cleaning. As used herein, the term “air rotor” refers to a dental abrasive device that rotates at high speed and uses compressed air as the driving force.

Moreover, in an embodiment, the pressure controlling unit may include the one or more outlet valves connected to a plurality of second tubes 280. The plurality of second tubes 280 may be adapted to provide a pathway for compressed air with the one or more second predefined pressures upon the step-down operation. Basically, for suction operation, about 5 bar pressure may be needed, whereas for the operation of the rest of the plurality of handpieces, about 2 bar pressure may be enough for the compressed air.

In a further embodiment, each of the plurality of second tubes 280 may be adapted to provide a coupling for each of the plurality of handpieces used for supplying the compressed air with the one or more second predefined pressures for at least one of the one or more dental treatment operations and suctioning out the waste fluids. In one exemplary embodiment, the one or more dental treatment operations may include cutting, scaling, grinding, polishing, cleaning, filling, and the like. Also, in an embodiment, the waste fluids may include saliva, blood, debris from the mouth, and the like.

Additionally, in an embodiment, the housing 190 may include a first bottle 290 for holding and supplying clean water for cooling, flushing, and cleaning during the dental treatment, via a plurality of third tubes 300. Similarly, in an embodiment, the housing 190 may further include a second bottle 310 for receiving and holding waste fluids when using the suction-based saliva ejector during the dental treatment. In one exemplary embodiment, the plurality of first tubes, the plurality of second tubes 280, and the plurality of third tubes 300 may be fabricated using poly urethane tubing for long life. In another exemplary embodiment, the plurality of first tubes, the plurality of second tubes 280, and the plurality of third tubes 300 may be fabricated using disposable plastic material.

Subsequently, in an embodiment, the dental treatment unit 25 may also include an electrical subsystem configured to provide electricity to one or more electrical-driven elements of the dental treatment unit 25. In one exemplary embodiment, the one or more electrical driven elements may include the motor, the one or more controllers, the one or more regulators, and the like. In one embodiment, a flow of electricity is controlled by a plurality of toggle switches.

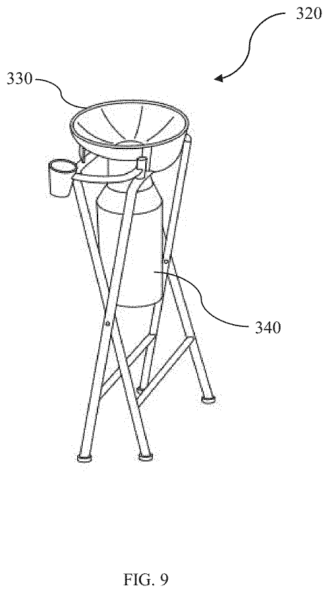

FIG. 9 is a schematic representation of an embodiment of an isometric view of a spittoon unit 320 of the integrated dental care system 10 of FIG. 1 in accordance with an embodiment of the present disclosure. In one exemplary embodiment, the integrated dental care system 10 may also include the spittoon unit 320. The spittoon unit 320 may include a spittoon bowl 330 and a spittoon bottle 340. The spittoon unit 320 may be adapted to mechanically couple to one of the pair of side chair arms 130, for enabling a user to spit mouth fluid onto the spittoon bowl 330. The spittoon bottle 340 may be adapted to receive and hold the mouth fluid.

In operation, a patient may use the dental recliner chair 20 for resting. Here, the patient may adjust the reclination of the back supporting frame 50 and the calf supporting frame 70 by mechanically adjusting the pair of side chair arms 130 over the pair of pivot points 120 by lifting and locking the pair of side chair arms 130 onto the pair of pivot points 120 via the plurality of serrated edges 160.

Moreover, in one exemplary embodiment, the patient pushes the back supporting frame 50 backward which in turn pushes the calf supporting frame 70 forward via the connecting shaft 150. Both, the back supporting frame 50 and the calf supporting frame 70 enable proper movement simultaneously. A doctor may use the plurality of handpieces stored in the dental treatment unit 25 and the plurality of instruments stored in the toolbox 230.

Here, the compressor unit allows the dentist to provide dry air for drying teeth after surgery. And the pressure controlling unit allows stepping down of pressure of the dry air for operating the plurality of handpieces. Also, bottles are provided for holding clean water and waste fluids.

Various embodiments of the present disclosure enable a dentist to visit the patient for performing the one or more dental treatment operations on the patient using the integrated dental care system. The integrated dental care system is a portable system, lightweight, and hence easy to carry. Further, the dental recliner chair is portable, rigid, and foldable for dental surgery usage. The dental recliner chair provides angular adjustment of seats between the seat supporting frame and the calf supporting frame, the feature enables users of different heights to easily adjust according to need. The patient with traditional dresses may also easily adjust to the portable dental recliner chair.

Moreover, the present disclosure also provides the dental treatment unit that provides a compact and a portable toolbox. The dental treatment unit is fabricated with Fiberglass Reinforced Plastic (FRP) material to provide a long life with less maintenance. Here, the dental treatment unit includes the compressor unit and the pressure controlling unit, for providing all required facilities during operations.

Further, a clean water system, an air supply system, and a waste collection system are also provided to enable proper medical facilities. Here, all the additional systems are fabricated inside the dental treatment unit. Additional equipment like pressure gauge and the like are retrofitted inside the dental treatment unit for the usage which makes the dental treatment unit portable. The present disclosure of the integrated dental care system may be used along with a digital platform for dental care services.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. An integrated dental care system, comprising:
a dental recliner chair; and
a dental treatment unit operatively coupled with the dental recliner chair,
wherein the dental recliner chair comprises:
a foldable chair frame comprising one or more frame components, wherein the one or more frame components comprises a contoured headrest element, a back supporting frame, a seat supporting frame, and a calf supporting frame mechanically coupled with each other at one or more coupling points,
wherein the foldable chair frame is adapted to fold at the corresponding one or more coupling points when operated by a user; and
a foldable chair supporting frame mechanically coupled to the foldable chair frame, wherein the foldable chair supporting frame comprises a U-shaped rear leg frame and a U-shaped front leg frame pivotally coupled with each other at a pair of pivot points, wherein the foldable chair supporting frame is adapted to enable folding and unfolding of the foldable chair frame when operated by the user; and
a pair of side chair arms, wherein each of the pair of side chair arms is pivotally coupled to the back supporting frame at a first end of the pair of side chair arms, wherein each of the pair of side chair arms comprises a plurality of serrated edges on a first surface of the corresponding pair of side chair arms, wherein the plurality of serrated edges is adapted to:
receive the pair of pivot points at a first serrated edge of the plurality of serrated edges for locking a reclination of the back supporting frame at a first reclination angle; and
vary the reclination of the back supporting frame from the first reclination angle to one or more second reclination angles, when a second end of the pair of the side chair arms is lifted and locked at one or more second serrated edges of the plurality of serrated edges by the user,
wherein the dental treatment unit comprises:
a housing comprising:
a compressor unit adapted to generate compressed air by compressing air to a first predefined pressure using a motor of a predetermined horsepower;
a pressure controlling unit operatively coupled to the compressor unit, wherein the pressure controlling unit is adapted to step down the first predefined pressure to one or more second predefined pressures for operating a plurality of handpieces; and
a plurality of ventilation openings to provide ventilation for preventing over-heating of the compressor unit; and
a toolbox detachably coupled to the housing, wherein the toolbox is adapted to hold a plurality of instruments essential to be used by a dentist for dental treatment.

2. The integrated dental care system of claim 1, wherein the dental recliner chair is adapted to be folded and packed in a backpack with shoulder pads.

3. The integrated dental care system of claim 1, wherein the contoured headrest element is adapted to provide support to a head of a user resting on the dental recliner chair.

4. The integrated dental care system of claim 1, wherein the reclination of the back supporting frame is adapted to control a reclination of the calf supporting frame via a connecting shaft, wherein the connecting shaft is pivotally coupled between the back supporting frame and the calf supporting frame.

5. The integrated dental care system of claim 1, wherein the compressor unit is adapted to store the compressed air in an aluminum tank.

6. The integrated dental care system of claim 5, wherein the aluminum tank comprises a plurality of outlets connected to a plurality of first tubes, wherein the plurality of first tubes is adapted to connect to one or more inlet valves of the pressure controlling unit for enabling the pressure controlling unit to receive the compressed air with the first predefined pressure.

7. The integrated dental care system of claim 1, wherein the pressure controlling unit comprises one or more outlet valves connected to a plurality of second tubes, wherein the plurality of second tubes is adapted to provide a pathway for compressed air with the one or more second predefined pressures upon the step-down operation.

8. The integrated dental care system of claim 7, wherein each of the plurality of second tubes is adapted to provide a coupling for each of the plurality of handpieces used for supplying the compressed air with the one or more second predefined pressures for at least one of one or more dental treatment operations and suctioning out waste fluids.

9. The integrated dental care system of claim 1, wherein the pressure controlling unit comprises at least one of one or more inlet valves, one or more outlet valves, one or more connectors, one or more actuators, one or more regulators, and one or more controllers operatively coupled with each other for enabling the stepping down of the first predefined pressure of the compressed air to the one or more second predefined pressures.

10. The integrated dental care system of claim 1, wherein the housing comprises an air filtration unit operatively coupled to the compressor unit, wherein the air filtration unit is adapted to filter the compressed air using a predefined filtration mechanism.

11. The integrated dental care system of claim 1, wherein the plurality of handpieces comprises at least one of a high-speed handpiece, a low-speed high-torque handpiece, a 3-way syringe, a suction-based saliva ejector, a water spray, and an air rotor.

12. The integrated dental care system of claim 1, wherein the housing comprises a first bottle for holding and supplying clean water for cooling, flushing, and cleaning during the dental treatment, via a plurality of third tubes.

13. The integrated dental care system of claim 1, wherein the housing comprises a second bottle for receiving and holding waste fluids when using a suction-based saliva ejector during the dental treatment.

14. The integrated dental care system of claim 1, wherein the housing is mounted on a trolley system for providing mobility to the dental treatment unit, wherein the trolley system comprises an adjustable handle and a plurality of wheels.

15. The integrated dental care system of claim 1, comprises a spittoon unit comprising a spittoon bowl and a spittoon bottle, wherein the spittoon unit is adapted to mechanically couple to one of the pair of side chair arms, for enabling a user to spit mouth fluid onto the spittoon bowl, wherein the spittoon bottle is adapted to receive and hold the mouth fluid.
